(19) United States
(12) Patent Application Publication
(10) Pub. No.: US 2013/0069777 A1
(43) Pub. Date: Mar. 21, 2013

(54) TURN SIGNAL STRUCTURE FOR SADDLE RIDE-TYPE VEHICLE

(71) Applicants: Yoshitaka SUZUKI, Wako-shi (JP); Kenji Tako, Wako-shi (JP)

(72) Inventors: Yoshitaka SUZUKI, Wako-shi (JP); Kenji Tako, Wako-shi (JP)

(21) Appl. No.: 13/606,449

(22) Filed: Sep. 7, 2012

(30) Foreign Application Priority Data
Sep. 19, 2011 (JP) 2011-203921

(51) Int. Cl. B60Q 1/34

(52) U.S. Cl. 340/475

(57) ABSTRACT

The visibility of turn signal lamps in an oblique lateral view of a vehicle is improved in a structure including the vertical long turn signal lamps located at front portions of shrouds. A turn signal structure includes a left and right pair of front forks pivotally supporting a front wheel with a vehicle body frame including a head pipe steerably supporting upper portions of the front forks. A headlight is placed in front of the head pipe with turn signal units respectively placed in front portions of shrouds disposed on left and right sides of a vehicle body. Front faces of the left and right shrouds respectively extend to lateral sides of the left and right front forks, and the turn signal units are placed at the front faces of the shrouds.

### CROSS-REFERENCE TO RELATED APPLICATIONS

The present application claims priority under 35 USC 119 to Japanese Patent Application No. 2011-203921 filed Sep. 19, 2011 the entire contents of which are hereby incorporated by reference.

### BACKGROUND OF THE INVENTION

1. Field of the Invention

The present invention relates to a turn signal structure for a saddle ride-type vehicle.

2. Description of Background Art

A turn signal structure for a saddle ride-type vehicle is known as set forth in Japanese Patent Application Publication No. 2009-073262. Description will be given below by using the reference numerals in the document. More specifically, the turn signal structure for a saddle ride-type vehicle includes a left and right pair of front forks (3) pivotally supporting a front wheel (2) with a vehicle body frame (5) having a head pipe (6) steerably supporting upper portions of the front forks (3). A headlight (60) is placed in front of the head pipe (6). Vertically long turn signals (57), respectively placed in front portions of shrouds (56), are respectively disposed on the left and right sides of a vehicle body.

### SUMMARY AND OBJECTS OF THE INVENTION

An object of an embodiment of the present invention is to improve the visibility of turn signal lamps in an oblique lateral view of a vehicle in a structure having the turn signal lamps in the front portions of the shrouds.

For the purpose of solving the foregoing problem, a turn signal structure for a saddle ride-type vehicle of an embodiment of the present invention is a turn signal structure for a saddle ride-type vehicle which includes a left and right pair of front forks pivotally supporting a front wheel with a vehicle body frame including a head pipe steerably supporting upper portions of the front forks. A headlight placed is in front of the head pipe with turn signal units respectively placed in front portions of shrouds disposed on left and right sides of the vehicle frame. Each turn signal unit including a lens unit with front faces of the left and right shrouds respectively extend to lateral sides of the left and right front forks with the turn signal units being placed at the front faces of the shrouds.

According to an embodiment of the present invention, the turn signal structure for a saddle ride-type vehicle includes the front faces of the left and right shrouds respectively extending to the lateral sides of the left and right front forks with the turn light units being placed in the front faces of the shrouds. Thus, the visibility of the turn signal lamps in an oblique lateral view of a vehicle can be improved while the left and right front forks are protected by the left and right shrouds without increasing the size of the turn signal lamps in a width direction.

In a side view, the head light may have a construction wherein its rear portion is placed between the left and right front forks and its front end is placed behind an intersection position between a front side of an outline of the front forks and a profile line of the front wheel.

This construction enables the headlight to be located rearward. Thus, the visibility of the turn signal lamps in the oblique lateral view of the vehicle can be improved even when the height of the front face of the shroud, namely the turn signal unit, is moved up close to the headlight. As a consequence, it is possible to move the height of the front face of the shroud, namely the turn signal unit, up close to the headlight, and to further improve the visibility of the turn signal lamps in the oblique lateral view of the vehicle.

Each turn signal unit may have a construction that includes the LED light source, and the board placed behind the LED light source and supporting the LED light sources. The shroud may have a construction that includes the duct configured to introduce a flow of air to the lateral side of the board.

This construction enables the board of the turn signal unit to be cooled down by means of the duct provided on the shroud.

The shroud may have a construction that makes the shroud protrude forward beyond the shaft center of the front fork in the side view.

The flow of air becomes turbulent behind the shaft center of the front fork. However, since the shroud extends forward beyond the shaft center of the front fork in a side view, a cooling effect can be enhanced by supplying the straightened flow of air having a high flow rate to either the turn signal lamp or the duct located at the front face of the shroud.

The turn signal unit may have a construction that includes the lens unit continuing from the front face to the upper face of the shroud.

This construction makes the upper face of the lens unit of the turn signal unit more visible with respect to a driver of the vehicle. Accordingly, the upper face of the lens unit of the turn signal unit can be made to serve as a turn signal indicator.

The turn signal unit may have a construction in which the LED light sources are placed in the upper and lower portions of the board and the turn signal unit has a single lens connecting the LED light sources to each other and including the vertically long portion in front of the board.

This construction can achieve cost reduction by decreasing the number of the LED light sources. At the same time, the visibility of the vertically long turn signal lamp can be ensured while preventing an increase in the temperature of the board.

The turn signal unit may have a construction in which the LED light sources are placed in front of the board and the turn signal unit has the single lens extending forward from the LED light sources and including the vertically long portion in front of the board.

This construction can achieve cost reduction by decreasing the number of the LED light sources. At the same time, the visibility of the vertically long turn signal lamp can be ensured while preventing an increase in the temperature of the board.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a front view of a motorcycle as an example of a saddle ride-type vehicle using a first embodiment of a turn signal structure for a saddle ride-type vehicle of the present invention;

FIG. 2 is a left side view of the motorcycle;

FIG. 3 is a partially omitted perspective view of the motorcycle;

FIG. 4 is a partially omitted front view showing a second embodiment;

FIG. 5 is a partially omitted side view of the second embodiment;

FIG. 6 is a partially omitted perspective view of a third embodiment;

FIG. 7 is a view showing a partially omitted perspective view and a cross-sectional view of a fourth embodiment;

FIG. 8 is a partially omitted perspective view of a fifth embodiment;

FIG. 9 is a partially omitted perspective view of a 6th embodiment; and

FIG. 10 is a partially omitted perspective view of a 7th embodiment.

### DETAILED DESCRIPTION OF THE PREFERRED EMBODIMENTS

Embodiments of a turn signal structure for a saddle ride-type vehicle of the present invention will be described below by referring to the drawings. In the drawings, the same or similar components are denoted by the same reference numerals.

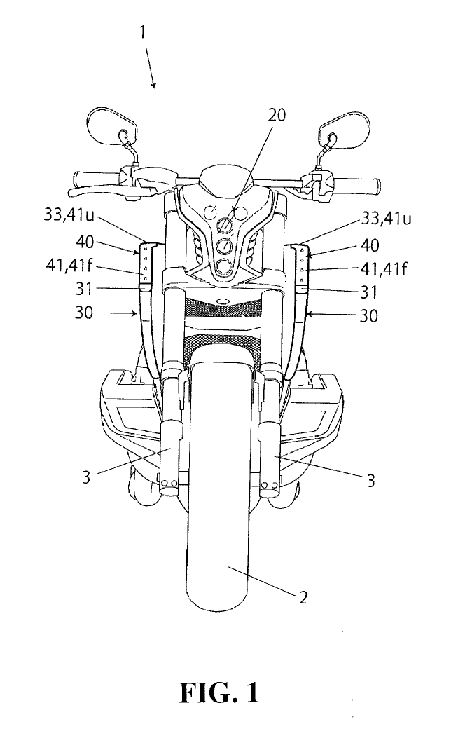

A saddle ride-type vehicle shown in FIG. 1 to FIG. 3 is a motorcycle.

This motorcycle 1 includes a left and right pair of front forks 3, 3 pivotally supporting a front wheel 2 with a vehicle body frame 10 having a head pipe 11 steerably supporting the upper portions of the front forks 3, 3. A headlight 20 is placed in front of the head pipe 11 with a fuel tank 6 supported by the vehicle body frame 10. Left and right shrouds 30, 30 are respectively placed on left and right sides of the fuel tank 6 that are configured to introduce a flow of air to an engine 7. Turn signal units 40 are respectively placed in the front portions of these shrouds 30, 30 with each turn signal unit 40 being provided with a vertically long lens unit 41 having a length in a vertical direction and/or a length in a front-back direction which is longer than a length in a vehicle width direction.

A turn signal structure of this motorcycle 1 is characterized in that front faces 31 of the left and right shrouds 30, 30 respectively extend to the lateral sides of the left and right front forks 3, 3 wherein the turn signal units 40 are placed in the front faces 31 of the shrouds 30, 30.

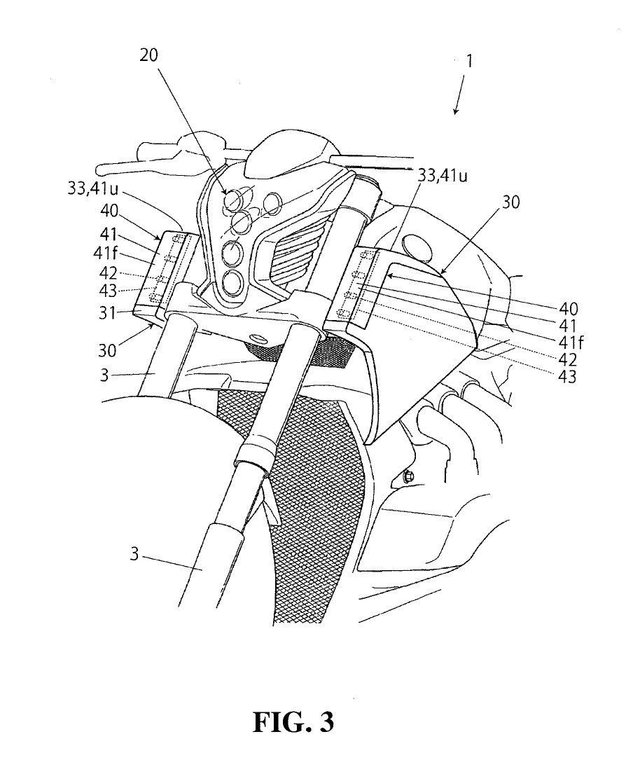

In the turn signal structure for a saddle ride-type vehicle, the front faces 31, 31 of the left and right shrouds 30, 30 respectively extend to the lateral sides of the left and right front forks 3, 3, and the turn signal units 40 are placed in the front faces 31 of the shrouds 30, 30. Thus, the visibility of turn signal lamps in an oblique lateral view of the vehicle can be improved as shown in FIG. 3 while the left and right front forks 3 are protected by the left and right shrouds 30, 30 without increasing the size of the turn signals (40) in a width direction.

In the illustrated embodiment, a front face 41f of a lens unit 41 of each turn signal unit 40 constitutes a part (an upper part in the drawing) of the front face 31 of the corresponding shroud 30. However, it is not always necessary to apply the above-described construction. The front face 41f of the lens unit 41 may protrude from the front face 31 of the shroud 30, or the front face 31 of the shroud 30 may protrude forward from the front face 41f of the lens unit 41 instead.

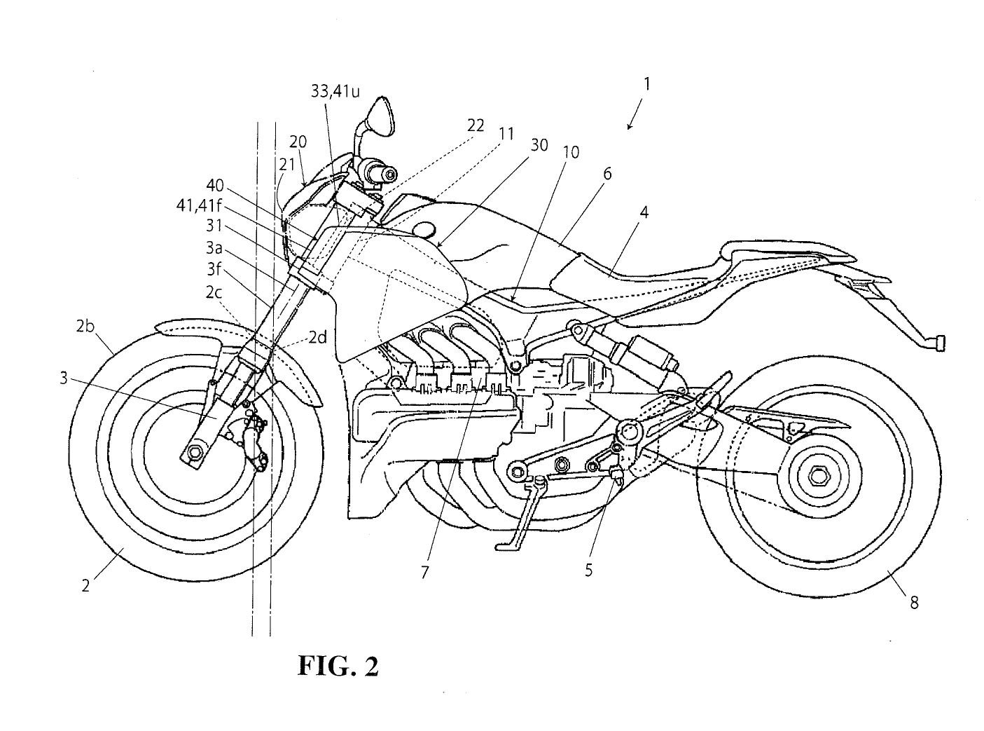

A rear portion 22 of the headlight 20 is placed between the left and right front forks 3, 3 in a side view (FIG. 2), and a front end 21 thereof is placed behind an intersection position 2c between a front side 3f of an outline of the front fork 3 and a profile line 2b of the front wheel 2.

This construction enables the headlight 20 to be placed rearward. Thus, the visibility of the turn signal lamps in the oblique lateral view of the vehicle can be improved even when the height of each turn signal unit 40 is moved up close to the headlight 20 (see FIG. 3). As a consequence, it is possible to move the height of the turn signal units 40 up close to the headlight 20, and to further improve the visibility of the turn signal lamps (40) in the oblique lateral view of the vehicle.

More preferably, the front end 21 of the headlight 20 is placed behind an intersection position 2d between a rear side 3r of the outline of the front fork 3 and the profile line 2b of the front wheel 2.

This construction can further improve the visibility of the turn signal lamps in the oblique lateral view of the vehicle.

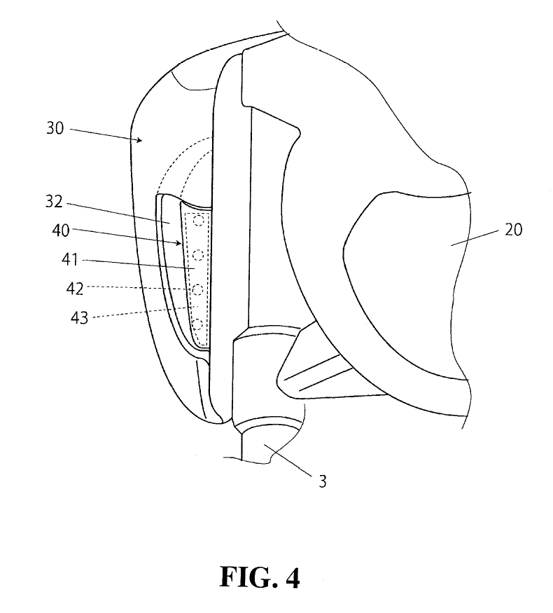

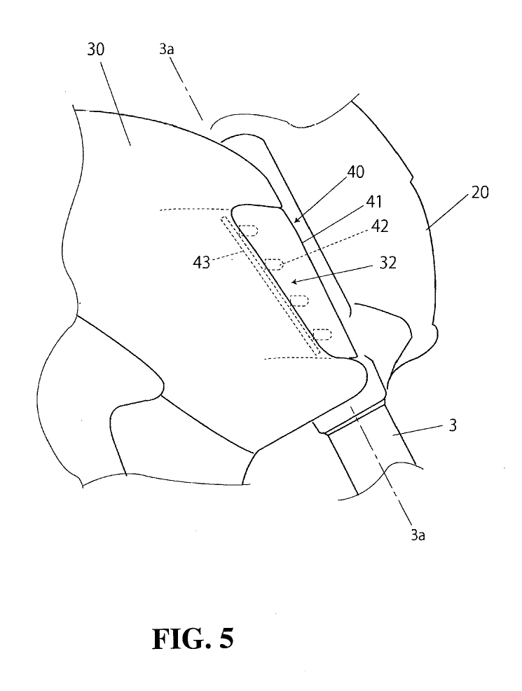

FIG. 4 is a partially omitted front view mainly showing the shroud 30 provided on the right side of the vehicle body, and FIG. 5 is a right side view thereof.

As shown in FIG. 4 and FIG. 5, the turn signal unit 40 may include LED light sources 42 and a board (a circuit board for the LED light sources 42) 43 placed behind the LED light sources 42, and supporting the LED light sources 42. The shroud 30 may have a construction that includes a duct 32 for introducing a flow of air to an outer side of the board 43.

By applying this construction, it is possible to introduce the flow of air to the board 43 of the turn signal unit 40 by means of the duct 32, and thereby to cool down the board 43.

The shroud 30 preferably has a construction that makes the shroud 30 extend forward beyond a shaft center 3a of the front fork 3 in a side view (see FIG. 2 or FIG. 5, for example).

The flow of air becomes turbulent behind the shaft center 3a of the front fork 3. Nonetheless, since the shroud 30 extends forward beyond the shaft center 3a of the front fork 3 in the side view, a cooling effect can be enhanced by supplying a straightened flow of air having a high flow rate, which flows outside the vehicle body, to either the turn signal lamps (40) or the duct 32 located at the front face of the shroud 30.

As shown in FIG. 2, the front face 41f of the lens unit 41 of the turn signal unit 40 is preferably arranged parallel to the front fork 3. This construction enables the flow of air to be straightened by means of the turn signal unit 40 and the front fork 3.

In FIG. 2, a seat 4 on which a driver gets seated is illustrated together with steps 5 on which the driver rests his/her feet on. A rear wheel 8 is driven by the engine.

As shown in FIG. 2, the turn signal unit 40 preferably includes a construction that includes the lens unit 41 extending backward from the front face 31 of the shroud 30 to a place where the seat 4 is located and continuing to an upper face 33 of the shroud 30.

This construction makes an upper face 41u of the lens unit 41 of the turn signal unit 40 more visible from the driver seated on the seat 4.

Accordingly, the upper face 41u of the lens unit of the turn signal unit 40 can be made to serve as a turn signal indicator.

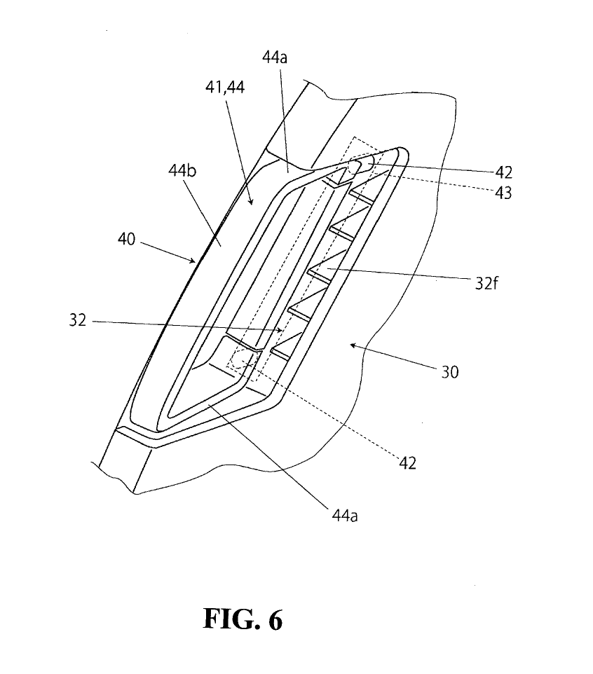

FIGS. 6 to 10 are perspective views of the shroud 30 provided on the left side of the vehicle body, which is viewed from a front left side.

As shown in FIG. 6, the turn signal unit 40 may have a construction wherein the LED light sources 42 are placed in the upper and lower portions of the board 43 and which includes a single lens 44 connecting the LED light sources 42 to each other and provided with a vertically long portion 44b in front of the board 43. The lens 44 constitutes the lens unit 41.

This construction can achieve cost reduction by decreasing the number of the LED light sources 42 (two in the drawing). At the same time, the visibility of the vertically long turn signal lamps can be ensured while preventing an increase in the temperature of the board 43.

The illustrated lens 44 includes the vertically long portion 44b and a pair of arm portions 44a extending backward integrally from the upper and lower portions of the vertically long portion 44b. The lens 44 is a C-shaped lens in terms of its overall shape in the side view. Light from the LED light sources 42 placed on the two opposite ends thereof is radiated out of the lens via the arm portions 44a and the vertically long portion 44b.

In the drawing, a duct 32 is provided together with flow straightening plates 32f provided to the duct 32 and extending backward as well as in the vehicle widthwise direction. The rigidity of the shroud 30 against an external force from an outer lateral side can be enhanced and the LED light sources 42 and the board 42 can be protected by placing the flow straightening plates 32f outside the LED light sources 42 and the board 43 in the vehicle width direction.

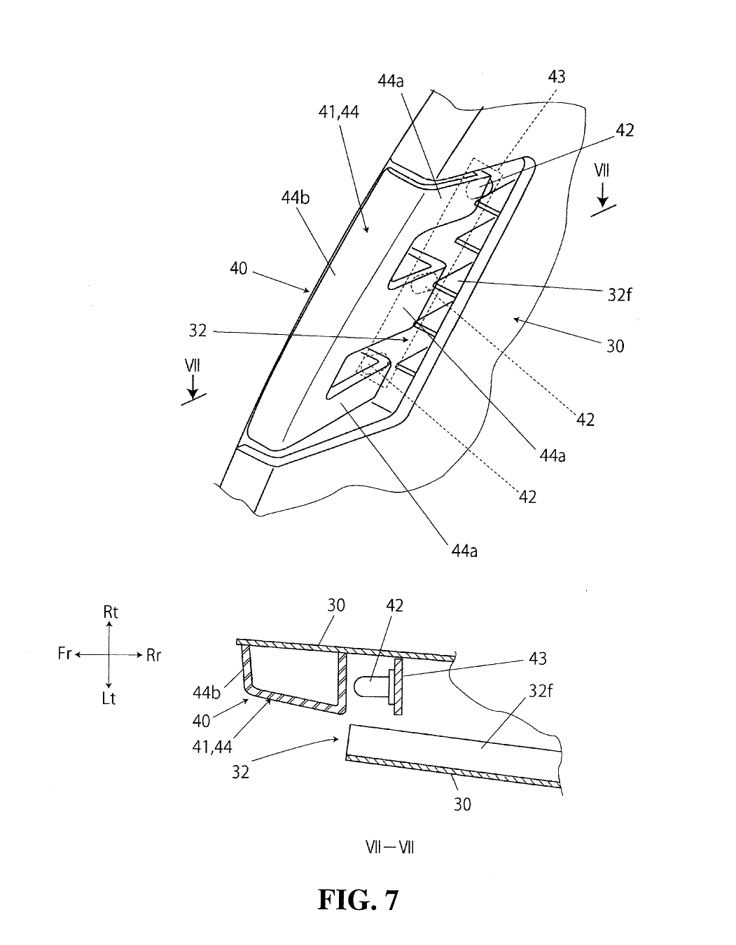

As shown in FIG. 7, the turn signal unit 40 may have a construction in which the LED light sources 42 are placed in front of the board 43 and which includes a single lens 44 extending forward from the LED light sources 42 and provided with a vertically long portion 44b in front of the board 43. The lens 44 constitutes the lens unit 41.

This construction can achieve cost reduction by decreasing the number of the LED light sources 42 (three in the drawing). At the same time, the visibility of the vertically long turn signal lamp can be ensured while preventing an increase in the temperature of the board 43.

The illustrated lens 44 is an E-shaped lens in terms of the overall shape, and includes the vertically long portion 44b and three arm portions 44a respectively extending backward integrally from the upper, lower and middle portions of the vertically long portion 44b. Light from the LED light sources 42 that are placed facing the arm portions 44a is radiated out of the lens via the arm portions 44a and the vertically long portion 44b.

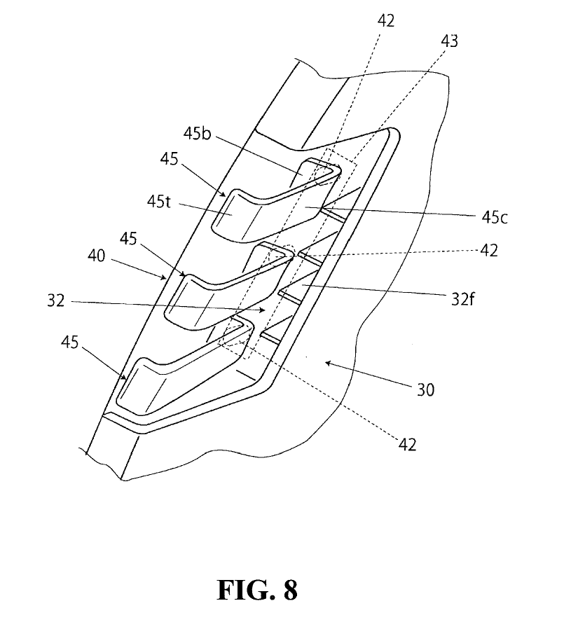

As shown in FIG. 8, the turn signal unit 40 may have a construction in which multiple LED light sources 42 (three in the drawing) are placed in front of the board 43 and which includes multiple lenses 45 extending forward from the respective LED light sources 42. The lenses 45 may collectively constitute the lens unit 41.

This construction can achieve cost reduction by decreasing the number of the LED light sources 42 (three in the drawing). At the same time, the visibility from lateral side of the vehicle can also be ensured while preventing an increase in the temperature of the board 43.

Each of the illustrated lenses 45 is a C-shaped lens in a plan view, and includes an opposed portion 45b facing the LED light source 42 an extending portion 45c extending integrally forward from this opposed portion 45b and a front face portion 45t integrally continuing to a front portion of this extending portion 45c. Light from the LED light sources 42 that are placed behind the opposed portions 45b, facing the opposed portions 45b, is radiated out of the lens via the opposed portions 45b, the extending portions 45c, and the front face portions 45t. Since each extending portion 45c is exposed on the lateral side of the vehicle, the visibility from the lateral side of the vehicle is improved. The same applies to the turn signal unit 40 shown in FIG. 7.

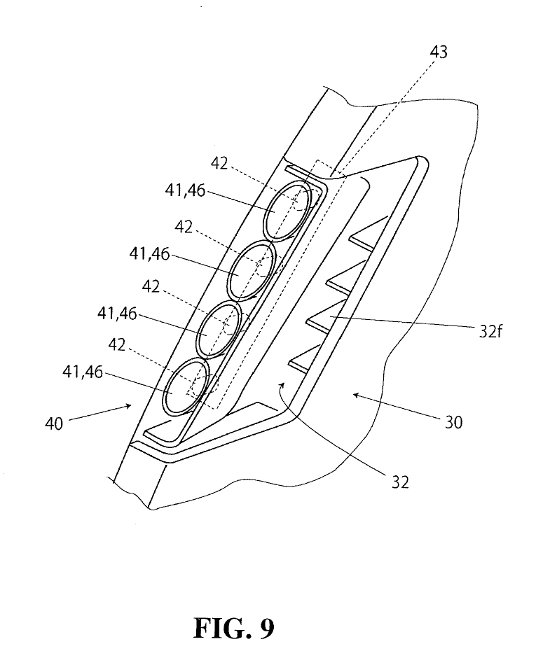

As shown in FIG. 9, the turn signal unit 40 may have a construction wherein multiple LED light sources 42 (four in the drawing) are placed in front of the board 43 and in which cylindrical inner lenses 46 are placed respectively in front of the LED light sources 42. The lenses 46 may collectively constitute the lens unit 41.

This construction can increase forward light intensity and improve the visibility from a front side.

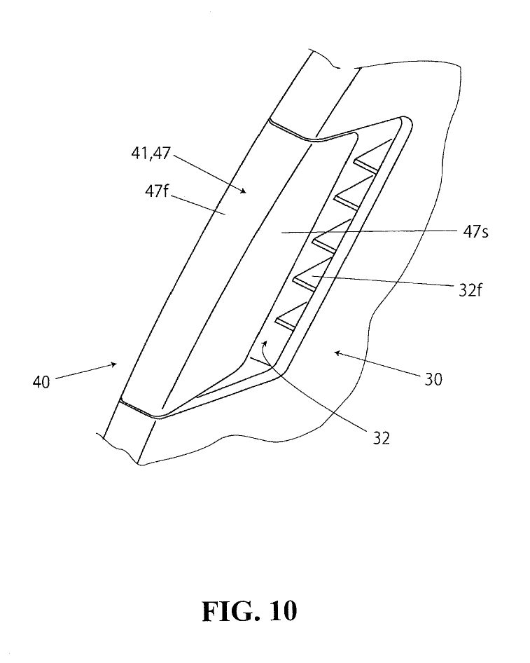

Each of the turn signal units 40 shown in FIG. 6 to FIG. 9 may have a construction that includes an external lens cover 47 as shown in FIG. 10. The external lens cover 47 includes a front portion 47f and a side portion 47s integrated therewith. The provision of the external lens cover 47 makes it is possible to obtain the visibility from the lateral side of the vehicle even in the case of the structure shown in FIG. 9, because the front portion 47f and the side portion 47s shine. The external lens cover 47 may constitute the lens unit 41.

While the structures shown in FIG. 6 to FIG. 10 represent the turn signal structure on the left side of the vehicle, the right side structure may also use similar configurations.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A turn signal structure for a saddle ride vehicle comprising:
a left and right pair of front forks pivotally supporting a front wheel;
a vehicle body frame including a head pipe steerably supporting upper portions of the front forks;
a headlight placed in front of the head pipe;
a fuel tank placed behind the head pipe;
turn signal units respectively placed in front portions of shrouds disposed on left and right sides of the fuel tank, each turn signal unit including a lens unit;
wherein front faces of the left and right shrouds respectively extend to lateral sides of the left and right front forks; and
the turn signal units are placed at the front faces of the shrouds.

2. The turn signal structure according to claim 1, wherein in a side view, the head light includes a rear portion placed between the left and right front forks and a front end placed behind an intersection position between a front side of an outline of the front forks and a profile line of the front wheel.

3. The turn signal structure according to claim 2, wherein:
each turn signal unit comprises an LED light source, and a board placed behind the LED light source and supporting the LED light sources; and
each shroud comprises a duct configured to introduce a flow of air to a lateral side of the board.

4. The turn signal structure according to claim 1, wherein each shroud protrudes forward beyond a shaft center of the front fork in a side view.

5. The turn signal structure according to claim 2, wherein each shroud protrudes forward beyond a shaft center of the front fork in a side view.

6. The turn signal structure according to claim 3, wherein each shroud protrudes forward beyond a shaft center of the front fork in a side view.

7. The turn signal structure according to claim 1, wherein each turn signal unit comprises the lens unit continuing from the front face to an upper face of the shroud.

8. The turn signal structure according to claim 2, wherein each turn signal unit comprises the lens unit continuing from the front face to an upper face of the shroud.

9. The turn signal structure according to claim 3, wherein each turn signal unit comprises the lens unit continuing from the front face to an upper face of the shroud.

10. The turn signal structure according to claim 4, wherein each turn signal unit comprises the lens unit continuing from the front face to an upper face of the shroud.

11. The turn signal structure according to claim 3, wherein:
in each turn signal unit, the LED light sources are placed in upper and lower portions of the board, and
the turn signal unit comprises a single lens connecting the LED light sources to each other and including a vertically long portion in front of the board.

12. The turn signal structure according to claim 4, wherein:
in each turn signal unit, the LED light sources are placed in upper and lower portions of the board, and
the turn signal unit comprises a single lens connecting the LED light sources to each other and including a vertically long portion in front of the board.

13. The turn signal structure according to claim 7, wherein:
in each turn signal unit, the LED light sources are placed in upper and lower portions of the board, and
the turn signal unit comprises a single lens connecting the LED light sources to each other and including a vertically long portion in front of the board.

14. The turn signal structure according to claim 3, wherein:
in each turn signal unit, the LED light sources are placed in front of the board, and
the turn signal unit comprises the single lens extending forward from the LED light sources and including a vertically long portion in front of the board.

15. The turn signal structure according to claim 4, wherein:
in each turn signal unit, the LED light sources are placed in front of the board, and
the turn signal unit comprises the single lens extending forward from the LED light sources and including a vertically long portion in front of the board.

16. The turn signal structure according to claim 7, wherein:
in each turn signal unit, the LED light sources are placed in front of the board, and
the turn signal unit comprises the single lens extending forward from the LED light sources and including a vertically long portion in front of the board.

17. The turn signal structure according to claim 11, wherein:
in each turn signal unit, the LED light sources are placed in front of the board, and
the turn signal unit comprises the single lens extending forward from the LED light sources and including a vertically long portion in front of the board.

18. A turn signal structure for a saddle ride vehicle comprising:
a vehicle body frame;
a fuel tank operatively mounted on the vehicle body frame;
shrouds disposed on left and right sides of the fuel tank;
turn signal units respectively placed in front portions of the shrouds, each turn signal unit including a lens unit;
wherein front faces of the left and right shrouds respectively extend to lateral sides of a left and a right front fork operatively connected to the vehicle body frame; and
the turn signal units are placed at the front faces of the shrouds.

19. The turn signal structure according to claim 18, wherein in a side view, the head light includes a rear portion placed between the left and right front forks and a front end placed behind an intersection position between a front side of an outline of the front forks and a profile line of a front wheel.

20. The turn signal structure according to claim 19, wherein:
each turn signal unit comprises an LED light source, and a board placed behind the LED light source and supporting the LED light sources; and
each shroud comprises a duct configured to introduce a flow of air to a lateral side of the board.
